(19) United States
(12) Patent Application Publication
(10) Pub. No.: US 2018/0354195 A1
(43) Pub. Date: Dec. 13, 2018

(54) INTEGRATED DESKTOP 3-DIMENSIONAL PRINTING APPARATUS

(71) Applicant: MCOR Technologies Limited, Ardee (IE)

(72) Inventors: Conor MacCormack, Ardee (IE); Fintan MacCormack, Ardee (IE)

(21) Appl. No.: 15/524,583

(22) PCT Filed: Nov. 4, 2015
(86) PCT No.: PCT/EP2015/075756

§ 371 Date: Jun. 25, 2018

(30) Foreign Application Priority Data
Nov. 4, 2014 (GB) 1449669.5

(51) Int. Cl. B29C 64/393; B29C 64/147; B29C 64/205; B33Y 30/00; B33Y 50/02

(52) U.S. Cl. CPC B29C 64/393; B29C 64/147; B33Y 50/02; B33Y 30/00; B29C 64/205

(57) ABSTRACT

There is provided a 3D printing apparatus (100) comprising: a printing module (200) comprising a print head for effecting printing of media layers at a print location; a build module (300) for receiving printed media layers (501A, 501B) from the print module and building the printed media layers to form a 3D object; and transport means (160) configured to transport media layers to the print location for effecting a printing of the media layers and to transport the printed media layers from the print location to the collator module. The printing and build modules are provided integrated in-line. The transport means provides continuous in-line transport of the media through the printing module to the build module.

### FIELD

The present application relates to Layered Object Manufacture (LOM) systems for rapid prototyping (RP), and in particular to a desktop apparatus that integrates conventional and 3D printing for printing 3-Dimensional (3D) object media layers to form a 3D object in a LOM system.

### BACKGROUND OF THE INVENTION

Rapid prototyping is defined as computer-controlled additive fabrication, in that an object can be fabricated by the addition of material rather than conventional machining methods that rely on removal or the subtraction of material. The term “rapid” is, it will be appreciated, a relative term but one that has specific meaning within the art, in that construction of a finished three dimensional article can take from several hours to several days, depending on the method used and the size and complexity of the model. There are many known methodologies that are employed within the general field of rapid prototyping. Layered Object Manufacture (LOM) is one form of Rapid prototyping (RP) which relates to the successive layering of adhesive-coated paper, plastic, or metal laminates which are then successively glued together and cut to shape with a knife or laser cutter.

LOM, similarly to other rapid prototyping techniques, conventionally involves the use of a three dimensional (3D) computer aided design (CAD) of an object/part to be made, from which a stereolithography (STL) or other suitable format file is generated within a CAD package. The STL file is processed and in effect virtually sliced in the Z-axis at a thickness matching the thickness of the substrate material used. This creates a series of cross sections of the part and at any particular height each one has a simple two dimensional (2D) profile. A profiling, or cutting, apparatus may be used to trace the 2D profiles and thus cut the shapes onto thin sheets of raw material. In LOM, each individual thin sheet may be stacked and bonded one on top of another to produce a finished 3D object. After a plurality of media object layers are formed, a profiling and layer bonding process is performed. The plurality of layers are bonded together, and then a profiling or weeding process is performed which comprises removing unwanted support material from the printed media stack to reveal the 3D printed object. The order of the profiling, stacking and bonding processes may be interchanged. The individual layers may also be printed using conventional 2D printing processes. The layers may be singly or duplex printed, and printed either in a single colour such as with black ink, or colour printed with a plurality of colours.

In LOM manufacturing, the printing, stacking, bonding and profiling processes may be performed in separate modules. Typically a finished 3D object is formed from a stack of individual media layers which are assembled and profiled to form the desired final geometrical shape. The individual media layers are printed or otherwise treated prior to the assembly arrangement. Accordingly, a plurality of 3D object media layers may be printed in preparation for forming the finished 3D printed article. The entire layer stack for the 3D printed article may be pre-printed off-line in the printing module, after which the printed stack may be loaded into the profiling and layer bonding module where each printed layer may be profiled and bonded to complete the fabrication of the 3D printed article.

Problems may arise in terms of alignment of the images printed on the opposite sides of the printed media layers in preparation for the collation and assembly into the final 3D object. Problems may also arise if the printed sheets provided as input to a 3-D printer are not in the correct order.

Some printers can be used to manufacture parts in colour. In one approach, for example, coloured sheets may be used. In another approach, for example, a coloured ink may be printed onto each sheet of paper or an image may be printed onto each sheet and the printed sheets may then be loaded into the section of the printer where the cutting and gluing occurs.

It will be appreciated that use of coloured sheets and/or inks and printing of images may add further complexity to the 3D printer machine and/or processes

Considerations in choosing a 3D printing machine include speed, cost of the 3D printer, cost of the printed prototype, and cost and choice of materials and colour capabilities. Often the cost of 3D printing is too high to be practical for most consumer applications. Furthermore, often currently available 3D printers are too large for consumer application.

The use of paper in SDL or LOM has brought down the cost of raw materials, but the size and complexity of printers remains an issue and there is a need to develop more compact and less complex printers, which can be produced more cheaply and fit on a consumer's home desktop.

There are therefore a number of issues with 3D printing processes in LOM systems for rapid prototyping that need to be addressed. The present application is aimed at providing an improved method of manufacturing coloured objects by LOM. The present specification is aimed also at providing an improved 3D printing system.

### SUMMARY

According to the specification there is provided a 3D printing apparatus comprising: a printing module comprising a print head for effecting printing of media layers at a print location; a build module for receiving printed media layers from the print module and building the printed media layers to form a 3D object; transport means configured to transport media layers to the print location for effecting a printing of the media layers and to transport the printed media layers from the print location to the collator module.
According to a further aspect there is provided a desktop 3D printing apparatus, comprising: a printing module for printing media layers, and a collator module for collating printed media layers to build a 3D object; and a feed mechanism having a first feed tray for receiving a plurality of media layers and configured to transport media layers from the first feed tray to a print location for effecting a printing of the media layers, and to transport the printed media layers from the print location to the build location for effecting a building of the 3D object. In one arrangement the duplex printing module and the collator module are provided coupled together in a single integrated apparatus and the feed mechanism is configured to transport individual media layers from an input through the printing module to collator module for assembly to form a 3D object in a continuous in-line process.
According to a further aspect there is provided a duplex printing module for a 3D printing apparatus comprising: a feed mechanism configured to: transport media layers from a first feed tray for receiving media layers for printing to a print location for effecting a printing of the media layers on a first side of the media layers, transport the first side printed media layers from the print location to the first feed tray, transport the first side printed media layers from the first feed tray to the print location for effecting a printing of that media on a second side, and transport the duplex printed media layers from the print location to a build location or 3D printing. In one arrangement the module further comprises a print head configured to print on a first side of a media layer and to print a machine readable position locator on the first side of a media layer, an optical reader configured to read the machine readable position locator and effect a change in position of the print head relative to a second side of the media layer to ensure correct alignment of print media to be provided on the second side relative to the printed media provided on the first side.
According to further aspect there is provided a duplex printing module comprising: a print head configured to print on a first side of a media layer and to print one or more machine readable position locators on the first side of the media layer, an optical reader configured to read the machine readable position locators and effect a change in orientation of at least one of: the print head relative to a second side of the media layer to ensure correct alignment of printing on the second side relative to the printing media provided on the first side, or the media layer relative to a profiling module for cutting the media layer.
Further there is provided a media layer feed mechanism for a 3D printing apparatus comprising a first feed tray, first feed mechanism and second feed mechanism configured to:
transport media layers from a first feed tray for receiving media layers for printing to a print location for effecting a printing of the media layers on a first side of the media layers,
transport the first side printed media layers from the print location to the first feed tray,
transport the first side printed media layers from the first feed tray to the print location for effecting a printing of that media on a second side, and
transport the duplex printed media layers from the print location to the build location.
   In one arrangement the feed mechanism comprises:
   a first feed mechanism configured to transport media layers a print location for effecting a printing of the media layers, and
   a second feed mechanism configured to transport printed media layers from the print location to the collator module. In one arrangement the second feed mechanism is configured to transport printed media layers from the print location to the first feed tray. In one arrangement the second feed mechanism is configured to reverse a first-side printed layer before transporting it to the first feed tray. In one arrangement the first feed mechanism comprises a feed roller. In one arrangement the second feed mechanism comprises a pick and place head.
   In one arrangement the desktop 3D printing apparatus further comprising a collator module configured to assemble a plurality of individual printed media layers to form a three-dimensional (3D) object. In one arrangement the collator module is configured to cut the individual media layers and bond the individual layers together to form the finished 3D object. In one arrangement the collator comprises a bonding module configured to bond individual ones of the plurality of media layers of individual media layers and a profiling module to cut the individual media layers.
   According to a first aspect there is provided a 3D printing apparatus comprising:
a printing module and a build module provided in a housing,
the printing module comprising a print head for printing of media layers at a print location, and
the build module comprising a build plate for receiving printed media layers from the print module, and adhesive dispensing means, cutting means, and bonding means for forming at the build location a 3D object from the printed media layers;
the apparatus further comprising a continuous media passage defined within the housing between a media input and the build location, and transport means for transporting a media layer from the media input along the media passage to the print location for printing of the media layer, and, to transport the printed media layer from the print location to the build module.
   In one arrangement, the build module is configured to manufacture the 3D object by selective deposition lamination (SDL). The printing module may be configured for single or duplex printing of media layers. In one arrangement, the printing module and build module are located integrally in a single housing. The transport means may further comprise a controller to control transport of media layers through the apparatus, and a sensor for sensing location and/or alignment of media layers at the print location and at the build location, and a feed mechanism for feeding the one or more media layers along the media passage.
   In one arrangement, the sensor is operable to sense the location of a media layer and/or to sense an image or mark printed on a media layer, and wherein the sensing means provides feedback of sensed information including location, identification or alignment data to the controller. The feed mechanism may further comprise one or more rollers and a pick and place head. The rollers and/or pick and place head may be further operable to correct errors in location or alignment of media layers. The print module may be configured for duplex printing of the medium, wherein a first image of an image pair to be printed on a media layer is printed on a first side of the medium and a second image of the image pair is printed on the second side of the medium back to back to the first image to define a printed media layer of the object. The apparatus may be configured to print marks on a first side of a media layer in a first printing pass. The apparatus may further comprise: a sensor configured to sense marks printed on a first side of a printed media layer; and a printhead configured to print on a second side of the media layer, the second side being an opposite side to the first side; wherein on sensing marks, the printhead position is adjusted to align with the marks.
   The marks may comprise fiducial marks. The fiducial mark may be a mark configured to provide information about the image printed on the first side of the medium, for example, a locator mark, or an image identifier to identify the image from the sequence of images for printing. The marks may comprise a portion of an image or the image printed on a first side of the sheet. The feed mechanism may comprise a feed roller wherein the feed roller is controllable to feed the media layer or adjust the media layer to align the printhead with the marks. The feed mechanism may comprise a feed tray for receiving a plurality of media layers in sheet form or receptacle for receiving the media layers in continuous roll form.
   In one arrangement, the feed mechanism comprise a pick and place roller positioned adjacent the feed tray wherein the roller is configured to pick a sheet from the feed tray and pass the sheet around the feed roller to the printhead. The feed roller may be configured to invert the sheet from a first orientation as it is passed around the feed roller. The apparatus may further comprise a pick and place head configured to grip the sheet after it has passed around the feed roller to place the sheet back on the paper feed tray. The apparatus may be configured for returning a media layer printed on a first side to the feed tray for feeding to the printhead for printing on the second side. The apparatus may be configured for duplex printing of a media layers and to transport a duplex printed media layer to the build module.
   In one arrangement, the print module and build module are arranged in-line in a single integrated apparatus, and the transport means is configured to transport each media layers in turn from an input tray to the print module and from the print module to the build module in a continuous in-line transport operation. In one arrangement, the print module and build module are configured to operate simultaneously, as media layers are transported through the apparatus. The print module and build module may be independently operable.
   Further the feed mechanism may comprises: a first feed mechanism for transporting media layers to a print location for effecting a printing of the media layers, and a second feed mechanism for transporting printed media layers from the print location to the build module. The second feed mechanism may be configured to transport printed media layers from the print location to the first feed tray. The second feed mechanism may be configured to reverse a first-side printed layer before transporting it to the first feed tray. The first feed mechanism may comprise a feed roller. In one arrangement, the second feed mechanism comprises a pick and place head. The pick and place head may be mounted for movement across the printing module 200 and the build module 300 of desktop 3D printing apparatus to locate or transport a media layer.
   According to another aspect there is provided a desktop 3D printing apparatus, comprising:
a printing module for printing media layers and
a collator module for collating printed media layers to build a 3D object; and
a feed mechanism having a first feed tray for receiving a plurality of media layers and configured to transport media layers from the first feed tray to a print location for effecting a printing of the media layers, and to transport the printed media layers from the print location to the build location for effecting a building of the 3D object;
wherein the printing module and the collator module are provided coupled together in a single integrated apparatus, and the feed mechanism is configured to transport individual media layers from an input through the printing module and to collator module for assembly to form a 3D object in a continuous in-line process.
   According to another aspect there is provided a duplex printing module for a 3D printing apparatus comprising:
a feed mechanism configured to:
transport media layers from a first feed tray for receiving media layers for printing to a print location for effecting a printing of the media layers on a first side of the media layers,
transport the first side printed media layers from the print location to the first feed tray,
transport the first side printed media layers from the first feed tray to the print location for effecting a printing of that media on a second side, and
transport the duplex printed media layers from the print location to a build location or 3D printing.
   The duplex printing module may comprise a print head configured to print on a first side of a media layer and to print a machine readable position locator on the first side of a media layer,
an optical reader configured to read the machine readable position locator and effect a change in position of the print head relative to a second side of the media layer to ensure correct alignment of print media to be provided on the second side relative to the printed media provided on the first side. The print head may be configured to move in X and Y directions relative to the plane of the media layer. The optical reader may be configured to read the machine readable position locator while the second side is positioned at a print location relative to the print head ready for printing. The optical reader may be configured to transmit position information of the machine readable position locator to a control unit for controlling the print head. On receipt of the position information, the control unit determines the adjustment required of the print head to ensure correct alignment of print media to be provided on the second side relative to the printed media provided on the first side. The alignment may be effected through a software control of the print head.
   According to another aspect there is provided a duplex printing module comprising:
a print head configured to print on a first side of a media layer and to print one or more machine readable position locators on the first side of the media layer,
an optical reader configured to read the machine readable position locators and effect a change in orientation of at least one of:
   the print head relative to a second side of the media layer to ensure correct alignment of printing on the second side relative to the printing media provided on the first side, or the media layer relative to a profiling module for cutting the media layer.
      The optical reader may be configured to read the machine readable position locators and effect a change in orientation of the print head relative to a second side of the media layer. The optical reader may be configured to read the machine readable position locators and effect a change in orientation of the media layer relative to a profiling module for cutting the media layer.
      According to another aspect there is provided a media layer feed mechanism for a 3D printing apparatus comprising a first feed tray, first feed mechanism and second feed mechanism configured to:
transport media layers from a first feed tray for receiving media layers for printing to a print location for effecting a printing of the media layers on a first side of the media layers,
transport the first side printed media layers from the print location to the first feed tray,
transport the first side printed media layers from the first feed tray to the print location for effecting a printing of that media on a second side, and
transport the duplex printed media layers from the print location to the build location.
   The feed mechanism may comprise:
a first feed mechanism configured to transport media layers a print location for effecting a printing of the media layers, and
a second feed mechanism configured to transport printed media layers from the print location to the collator module.
   The second feed mechanism may be configured to transport printed media layers from the print location to the first feed tray. The second feed mechanism may be configured to reverse a first-side printed layer before transporting it to the first feed tray. The first feed mechanism may comprise a feed roller. The second feed mechanism may comprise a pick and place head.
   According to another aspect there is provided a desktop 3D printing apparatus comprising the duplex printing module as set out above, or the media layer transport system as described.
   According to another aspect there is provided a desktop 3D printing apparatus of as described above further comprising a collator module configured to assemble a plurality of individual printed media layers to form a three-dimensional (3D) object. The collator module may be configured to cut the individual media layers and bond the individual layers together to form the finished 3D object. The collator may comprise a bonding module configured to bond individual ones of the plurality of media layers of individual media layers and a profiling module to cut the individual media layers.
   The feed mechanism may defines a medium transport path, wherein the medium is transported to a first print station for printing on a first surface of the medium and from the first print station to a second print station for printing on a second surface of the medium. The first and second print stations may be co-located. The first and second print stations may be located spaced apart. The apparatus may comprise a printhead, wherein the printhead is moveable between the first and second printing stations to effect printing on the first surface of the medium and on the second surface of the medium. The apparatus may comprise first and second printheads for printing simultaneously on first and second surface of the medium at first and second print stations. The first and second print heads may be arranged to print the first and second surfaces of the sheet as the sheet is between the print heads.

### BRIEF DESCRIPTION OF THE DRAWINGS

The present application will now be described with reference to the accompanying drawings in which:

FIG. 1 is a block diagram of a LOM apparatus according to an embodiment of the present teaching;

FIG. 2 is a front elevation view of a 3D desktop printing apparatus in a first stage of operation in accordance with the present teachings;

FIG. 3 is an isometric view of the 3D desktop printing apparatus of FIG. 2;

FIG. 4 is a front elevation view of a 3D desktop printing apparatus of FIGS. 2 and 3 in a second stage of operation in which a sheet printed on a first side is returned to the feed tray for representation to the printer for printing on a second side;

FIG. 5 is an isometric view of the 3D desktop printing apparatus of FIG. 4 in the second stage of operation in which the second side is printed;

FIG. 6 is a front elevation view of a 3D desktop printing apparatus of FIGS. 2 to 5 in a later stage of operation in which a printed media layer is transferred to a build module;

FIG. 7 is an isometric view of the 3D desktop printing apparatus of FIG. 6; and

FIG. 8 is an illustration of an alternative arrangement according to the present specification which provides for individual sheets to be picked up and rotated first 90 degrees and pass through the horizontal ink printheads, then rotated another 90 degrees into the build area, where the sheet is grabbed by a multifunctional grab head and transferred to the build location.

### DETAILED DESCRIPTION OF THE DRAWINGS

Exemplary arrangements of a desktop printing apparatus that uses Selective Deposition Lamination (SDL) in accordance with the present teaching will be described hereinafter to assist with an understanding of the benefits of the present teaching. Such arrangements will be understood as being exemplary of the type of apparatuses that could be provided and are not intended to limit the present teaching to any one specific arrangement as modifications could be made to that described herein without departing from the scope of the present teaching.

The present specification provides an SDL desktop apparatus that integrates conventional printing and 3D printing. The apparatus is configured to print and assemble a plurality of individual media layers to form a three-dimensional (3D) object. Within the context of the present teaching, the individual media layers may be considered distinct physical elements or entities.

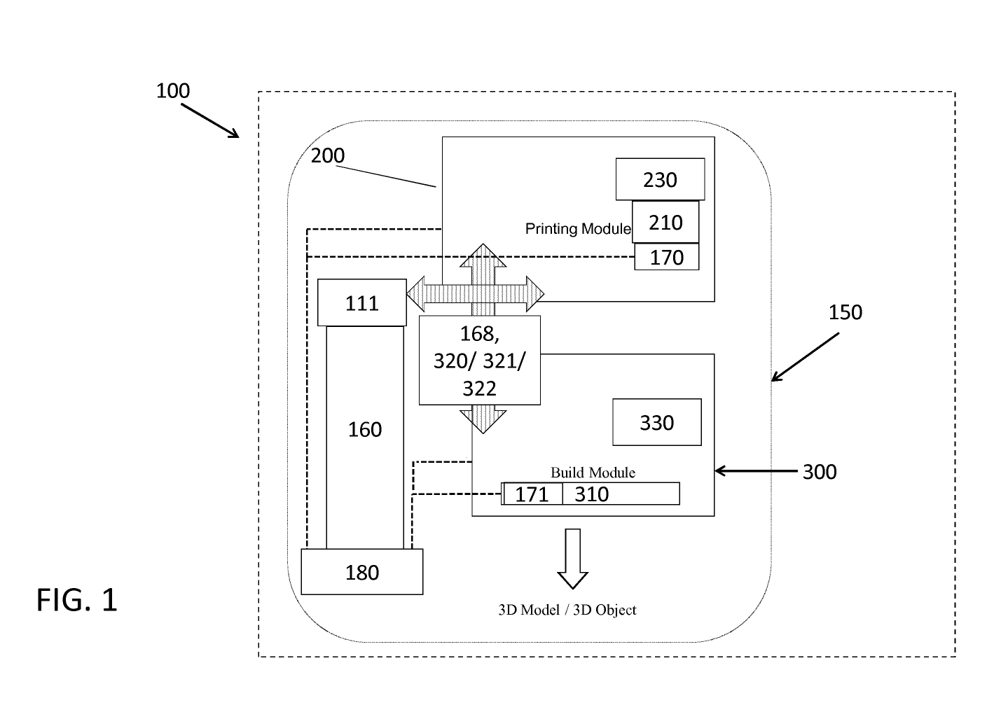

FIG. 1A is a block diagram of a desktop SDL apparatus 100 according to the present specification. The desktop SDL apparatus (3D printing apparatus) 100 comprises a printing module 200, and a SDL build module 300. The printing module may be configured to print a plurality of media layers, and the build module to assemble the plurality of the individual media layers to form the 3D object. The media layers may be printed with a single black ink, or colour printed with a plurality of colours or no colour—i.e. white. The build module includes the necessary features—profiling or cutting means, adhesive application and bonding means for building and assembling the individual 3D object media layers together to form the finished 3D object. The printing module 200 and the build module 300 are integrally coupled within the apparatus 100 such that media layers may be single-side or duplex printed in the printing module 200 before being transported to the build module 300 to produce the completed 3D object.

In the specification the build module describes the module of the 3D printing which the layered objects are assembled to form the 3D object. The terms build module, collator module, build chamber and build module, SDL build module have variously been used to describe this feature.

Media layers are transported to the printing module 200 for 2D printing. The printed media layers are transported from the printing module to the build chamber for collation and assembly of the final 3D object in an SDL process.

Media layers in the arrangement described are provided in sheet form. The media layers are preferably of paper, however, it will be appreciated that any sheet material may be used. The media is provided to the desktop apparatus 100 to be 2D printed, profiled and bonded, thereby producing a completed colour 3D object.

The printing module may comprise a conventional 2D printer configured to apply the ink to the media layers prior to collation. The 2D printer may be a standard inkjet printer. The printing module may be configured to print on one surface only or on first and second surfaces of the media layers. The printing on first and second surfaces operably reduces image bleed and preserves colour accuracy regardless of angle of the object's surface. The printing module may be configured to apply multiple colours to one or more surfaces of one or more of the plurality of individual media layers.

In the specification, the terms grab head, multi-functional head and pick and place head have variously been used to describe and refer to the head mounted for movement over the print module and build module to pick and place sheets for printing and/or to the build location. The head may for example be mounted to an X-Y frame and movement is controlled by the control means of the printing apparatus 100. The head arrangement provides high levels of flexibility and of control in operation. The head may be used to location and also to correct location of alignment of a media layer, in the event that any error or misalignment is detected.

Media layers are transported to the printing module 200 for 2D printing. The printed media layers are transported from the printing module to the build chamber for collation and assembly of the final 3D object in an SDL process.

Images 600A and/or 600B printed on a media layer 501 are printed in accordance with a pre-generated digital print file containing image, profile and colour information for the 3D object to be printed.

Steps in an exemplary arrangement of pre-generating a digital print file are briefly explained herein, however, it will be appreciated that alternative methods may be provided. As is known in the art, 3D printing starts with a 3D data file, which is representative of the 3D object to be printed. For example the universal industry standard file format for 3D product designs, STL, as well as OBJ and VRML (for colour 3D printing) can be used with the present teaching, however, it will be appreciated that suitable alternatives may also be used. Colour is then generated and applied to the model represented in the data file. The data in such files is read and the computer model is sliced into printable layers equivalent in thickness to the media layer. Such generation of the data file usually takes place at a PC or computing device connected to the printer 100 however this should not be interpreted as limiting as such processing may also take place in the printing apparatus 100. It will be appreciated that in alternative arrangements the slicing could be performed in the cloud, or on a mobile device, tablet, phone. Furthermore the present teachings are not limited to the above method of file generation and any suitable method of generating 3D print files may be used.

The pre-generated digital print file is provided or otherwise loaded to the printing apparatus 100 prior to beginning the print job and SDL job. Although not shown, the printing apparatus 100 includes a processor or controller and as well as memory onto which the print file is loaded.

The digital print file is again referenced or read by the controller/processor. The digital print file may comprise a series of top-side-bottom-side image pairs 600A/600B for each media layer 501. Colour image information for both the first side and the second side for all media layers is also contained in the digital print file.

FIG. 1 is a block diagram of a desktop LOM (Layered Object Manufacturing) apparatus 100 according to the present specification. The desktop LOM apparatus (3D printing apparatus) 100 comprises a printing module 200 and a build module 300. The printing module is configured to print a plurality of media layers, as required depending on object specification, and a collator module configured to assemble the plurality of printed media layers to form the 3D object. The media layers may be printed with a single black ink, or colour printed with a plurality of colours. Each of the individual media layers may be individually or independently printed. The build module may comprise profiling or cutting means to cut the individual 3D object media layers and bonding means to bond the individual media layers together to form the finished 3D object. The printing module 200 and the build module 300 are integrally coupled within the apparatus 100 such that media layers may be single-side or duplex printed in the printing module 200 before being transported directly to the build or collator module 300 to produce the completed 3D object.

Media layers are transported to the printing module 200 for 2D printing. The printed media layers from the printing module are then transported to the build module 300 for collation and assembly of the final 3D object in an SDL process.

Media layers 501A, 501B are in the arrangement described provided in the form of sheets 501. The sheets 501 are preferably sheets of paper provided to the desktop apparatus 100 to be 2D printed, and profiled and bonded, to produce a completed colour 3D object. The apparatus 100 comprises a media feed or media transport module 150. The feed or transport module 150 comprises feed means or transport means 160 for transporting the media from a media input 111 though the printing module 200 for single-side or duplex printing and to the build module 300 for assembly to form the desired SDL build object 700. The transport module 160 further comprises sensing means 170/171 coupled to control means 180 for control of transport. Sensing means 170/171 provide detection and correction in real-time of any feed error or misalignment of the media layers during printing or collating or building stages. Transport through the stages of printing (2D printing) and building (3D printing) is provided in a continuous in-line arrangement and method. The apparatus of the present specification provides single sided or duplex printing and 3D printing in a continuous in-line method and apparatus.

In an exemplary arrangement of the specification, described further below with reference to FIGS. 1-6, feed or transport means 150/160 comprises feed roller 161, sensor 170 and pick and place (grab) head 168. The grab head may further or alternatively comprise a sensor 172. The apparatus 100 defines a media transport path 140 from media input 111 to the build plate 310. The media layer path or passage 140 is a continuous path or passage through the apparatus and the feed mechanism including rollers and pick and place head and guides transport the media layers along the passage continuously for processing.

Each sheet is fed from the input tray to the print location where it is printed on one or both sides, as required. Each sheet is transported in turn from the print location to the build location. Transport through the system is continuous. The apparatus includes detection means and control means for controlling the apparatus and transport via the media layer passage by the feed mechanism. Each sheet is transported through the apparatus continuously from input to the build location in turn.

The printing module 200 comprises a 2D printer for applying the ink to the media layers prior to collation. The 2D printer may be a standard inkjet printer. The printing module 200 comprises a print head 230. The print head 230 is configured to print on first and second surfaces of the sheets or media layers at a print station 210. The printing on first and second surfaces operably reduces image bleed and preserves colour accuracy regardless of angle of the object's surface. The printing module may be configured to apply multiple colours to one or more surfaces of one or more of the plurality of individual media layers. The build module 300 comprises a bonding module for bonding individual ones of the plurality of media layers 501 and a profiling module configured to effect a profiling of individual ones of the plurality of media layers to effect a desired 3D shape within the 3D object. The build module 300 comprising profiling and bonding means may be integrated in a single profiling and layer bonding module.

In accordance with the present teaching a finished 3D object is formed at collator or build module 300 from a stack of individual media layers 501 which are assembled and profiled to form the desired final geometrical shape. Each of the media layers 501 of the 3D printed article may be singly or duplex printed in the printing module. After printing the printed media layers 501 are fed directly into the build module where each printed layer may be profiled and bonded to complete the fabrication of the 3D printed article.

It is noted that the terms media layers or media sheets, paper sheets and medium have been used in the specification to describe the media and the media layers provided to form layers of the 3D object. In a preferred arrangement the media layers may be conventional sheets of cellulose based paper or sheets of cellulose based paper cut from a roll. The individual media layers may be sheets of cellulose based paper which may be printed or otherwise treated prior to the assembly arrangement. In a preferred arrangement, the media layers may be sheets of A4-sized paper. Accordingly, a plurality of 3D object media layers—such as the exemplary cellulose based paper, may be printed in 2D and 3D for forming the finished 3D printed article.

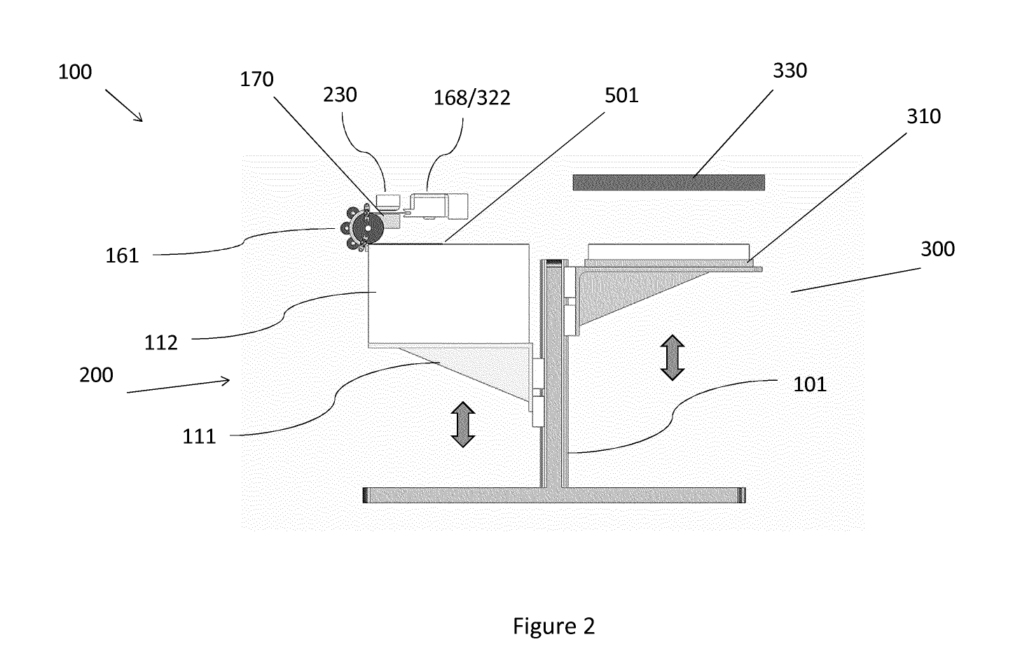

Referring to FIG. 2 a desktop printing apparatus 100 of an exemplary arrangement according to the present specification is described. Apparatus 100 includes printing module 200 and build module 300. Printing module 200 includes a feed tray 111 for receiving a stack of media layers or sheets 501 and feed roller 161 and print head 230. A sheet 501 is printed at print station 210. In the exemplary arrangement media layers are sheets of paper 500. The apparatus 100 includes sensor 170 provided for sensing a sheet or an image or mark on the sheet 501 at the feed roller 161 or at the print station 210. Apparatus 100 further includes grab (pick and place) head 168 provided to grab a sheet exiting the feed roller 161. Collator or build module 300 includes build plate 310 and press plate 330. The build module 300 includes adhesive dispensing means 320, cutting means 321, and bonding means 330 for building the 3D object. Build plate 310 defines a build chamber or build location for assembly of the 3D object from the printed media layers. In the exemplary arrangement of FIG. 2 the feed tray 111 and build plate 310 are both movably mounted to a common frame 101. Feed tray 111 and build plate 310 are movable between first lower position and second upper position, as required.

Head 168 has been described above as a pick and place (grab) head, which function is used in the printing module 200 of the apparatus 100. In a preferred arrangement the grab head 168 is provided integrally with a multifunctional head 322 of the apparatus 100. Multifunctional head 322 comprises grab head 168 operable at the printer module 200 to assist in transporting sheets for printing and for transporting printed sheets from the print module 200 to the build location 310. In a preferred arrangement the multifunctional head 322 may further comprise a sensor 172, cutting means 321 for cutting or dicing a media layer of the build object and adhesive dispensing means 320 for dispensing adhesive to a media layer of the build object. Further, sensor 172 may be used for positioning of grab head 168/322 relative to the printing and collating modules. Such sensors may also be used by the grab head 168/322 to determine the correct location to engage or grip a media layer 501 as it emerges from between the print head 230 and the sensor 170.

Sensor 170 may in a preferred arrangement be an optical reader. Similarly sensor 172 if provided may be an optical sensor. For example, if marks printed on the first side of a sheet comprise printed fiduciary or fiducial marks 605 the sensor may be configured to detect such marks. Sensor 170 or 172 in an alternative arrangement may be a vision inspection type sensor. Sensor type may be selected depending on whether it is desired that an image be recognised or image features be detected or whether marks are to be read. As noted above feed module 150/160 may include further sensing means. Build module 300 may include an additional sensor 171 for sensing image or marks to determine any misalignment in the presentation of a media layer to the build plate 310.

The apparatus 100 provides integrated in-line a 2D printing module 200 and a build module (3D printing module) 300. Transport means 160 is provided to convey the medium 501 to be printed and used to form the layers of the build object from the input through printing and to the build module. Transport is a continuous in line transport.

The print module and build module are arranged in-line in a single integrated apparatus, and the transport means is configured to transport the medium from an input to the print module and to the build module in a continuous in-line transport operation.

The multifunctional head 322 and/or grab head 168 is mounted for movement across the printing module 200 and the build module 300 of desktop 3D printing apparatus 100, as required. Control means 180 is provided to control the location and operation of the multifunctional head 322 and/or grab head 168 and/or transport means 150/160 and/or sensors 170/171. The multifunctional head 322 may in a preferred arrangement be mounted on an X-Y frame for movement over the print module 200 and the collator module 300.

In the exemplary arrangement, the media layers 701 are standard sheets 501 of printing paper. The feed tray 111 provides individual sheets 501 to a feed roller 161. Feed roller 161 receives a sheet 501 from feed tray 111 and feeds the sheet 501 to the printhead 230 and to grab head 168 (or multifunctional head 322).

Feed tray 111 is moveable between a first lower position and a second upper position. The feed tray 111 is moveable to the lower position for filling and refilling. The feed tray 111 is moveable to the upper position for feeding a sheet 501 from the top of the stack to the feed roller 161. The feed tray 111 may be biased in the direction of the upper position for feeding a media layer to the feed roller. The feed tray 111 may be pre-loaded with a sufficient number of sheets 501 to complete a print job when preparing a print run. However, a print run may be paused to reload the feed tray 111.

As will be appreciated, the feed roller 161 of FIG. 2 shows an exemplary arrangement of a feed roller for picking a sheet 501 from the feed tray 111 and presenting it from the feed roller 161 for subsequent printing and processing to the print head 230. The media layer 501 is inverted as it is carried by the roller 161 for presentation to the print head 230.

Each of the media layers or sheets 501 has a first surface 505A and a second surface 50513. The present system is configured for printing an image on at least a portion of one or both of the surfaces of a sheet 501. The in use orientation of the sheets 501 and each surface of the sheets is herein noted for the purpose of further describing the stages of the duplex printing process of the exemplary arrangement. It is assumed that the sheets are provided loaded in the feed tray 111 in a first in use orientation such that the first surface 505A faces downwardly to the feed tray 111 and the second surface 50513 faces upwardly from the stack 112. The feed roller 161 is configured to pick a single sheet 501 from the feed tray 111 i.e., from the top of the stack 112 of media layers, and to rotate the sheet 501 about 180 degrees of the roller 161 and to feed the media layer out from the roller. Each media layer 501 that is so rotated about the roller emerges inverted from the roller 161 such that the first surface 505A is now facing upwardly for printing.

Upon emerging from the outlet portion of the roller 161, the inverted media layer 501 passes between print head 230 and sensor 170. In the exemplary arrangement the print head is located in proximity to the outlet portion of the feed roller 161. The print head 230 is configured to print at least a portion of a first surface of the media layer 501. The media layer 501 may be printed with a single black ink, or colour printed with a plurality of colours. The print head 230 may be configured to print an image 600B on the first surface, the image relating to a layer of the 3D object. The print head 230 may be further configured to print fiduciary marks 605 and an image 600B on the same side of the media layer 501 i.e., the first surface 505A. The image printed on the media layer 501 is printed in accordance with a pre-generated digital print file containing image, profile and colour information for the 3D object to be printed, which as noted above provides for printing on each sheet an image pair 600A and 600B for printing back to back on the sheet to define a media layer of the object.

The fiduciary marks 605 may be are printed on the same side of the media sheet 501 as the image 600B printed in the first stage to provide positional information with respect to the image as will be explained in more detail below.

The print head 230 may be any suitable print head used on a conventional 2D printer configured to apply the ink to the media layer as it is fed from the roller 161. For example, the print head 230 may be a standard inkjet printer.

As the media layer 501 passes between the print head 230 and sensor 170, grab head 168 (322) grips the media sheet 501. The grab head 168 (322) is configured to move across the top of the feed tray 111 such that as the media layer 501 is fed through the feed roller 161. The grab head 168 may further simultaneously moves assists in moving the media layer 501 away from feed roller 161. The grab head 168 (322) is configured to engage the media layer 501 and guide the media layer 501 away from the feed roller 161, print head 230 and sensor 170.

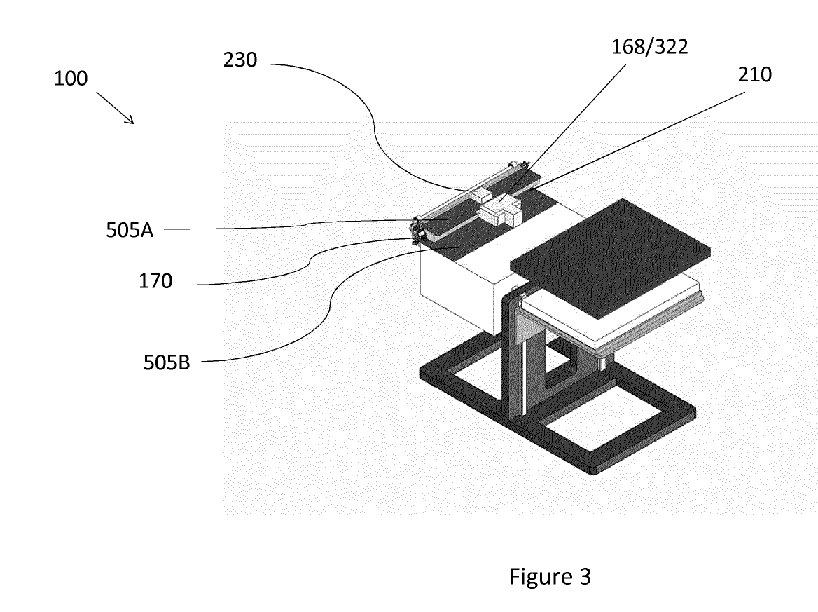

FIG. 3 is an isometric view of the 3D desktop printing apparatus 100 of FIG. 2. In this view, the process is at the same stage as in FIG. 2 i.e., the media layer 501 is being fed through the feed roller 161 for printing on a first side 505A of the media layer. The portion of the media layer that has emerged from the top of the feed roller 161 is being printed by the print head 230 i.e., an image 600B is printed on the first side 505A (upwardly facing side) of the media layer 501. In addition, fiduciary marks 605 may be printed on the same side of the media layer 501.

In the exemplary arrangement of FIGS. 2 and 3, the print head 230 does not extend across the longitudinal extent of the media layer 501 but is configured to move from side to side to effect printing of the media layer 501. However, it will be appreciated that a stationary print head that spans the length of the media layer 501 may also be used. As previously mentioned, the print head 230 may be configured to print both fiduciary marks 605 and an image 600B on the media layer 501 as it is passes the print head 230.

The image or fiduciary marks 605 if provided may be sensed by the sensor 170 or sensor 172 at a second stage of the printing process. Fiduciary marks 605 may include location or identification information. The sensing of the printed image or fiducial marks is used in locating the sheet for printing the second side.

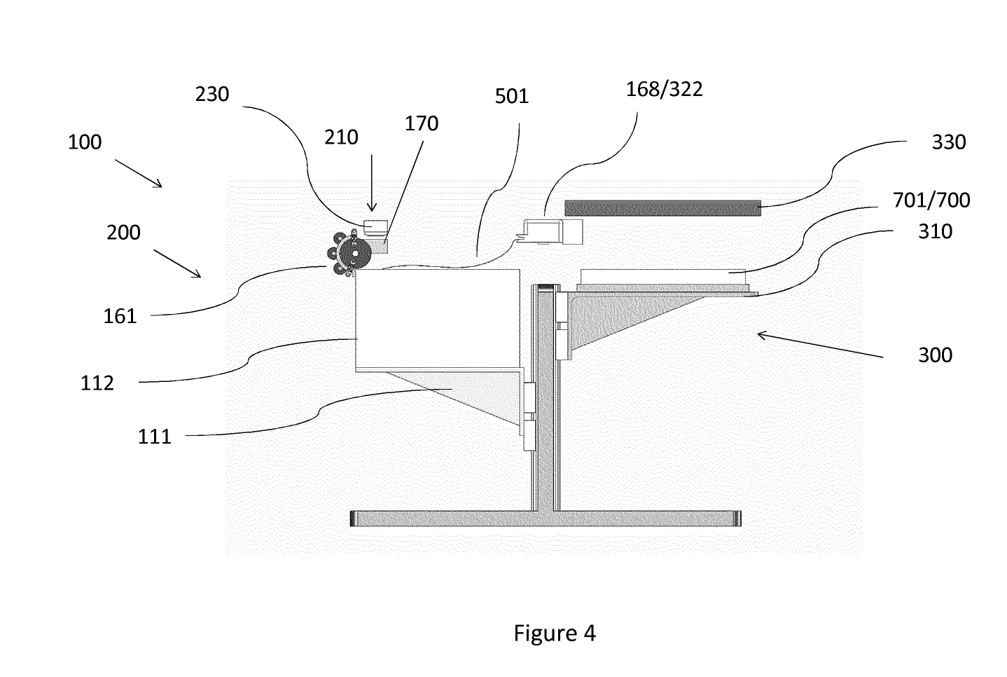

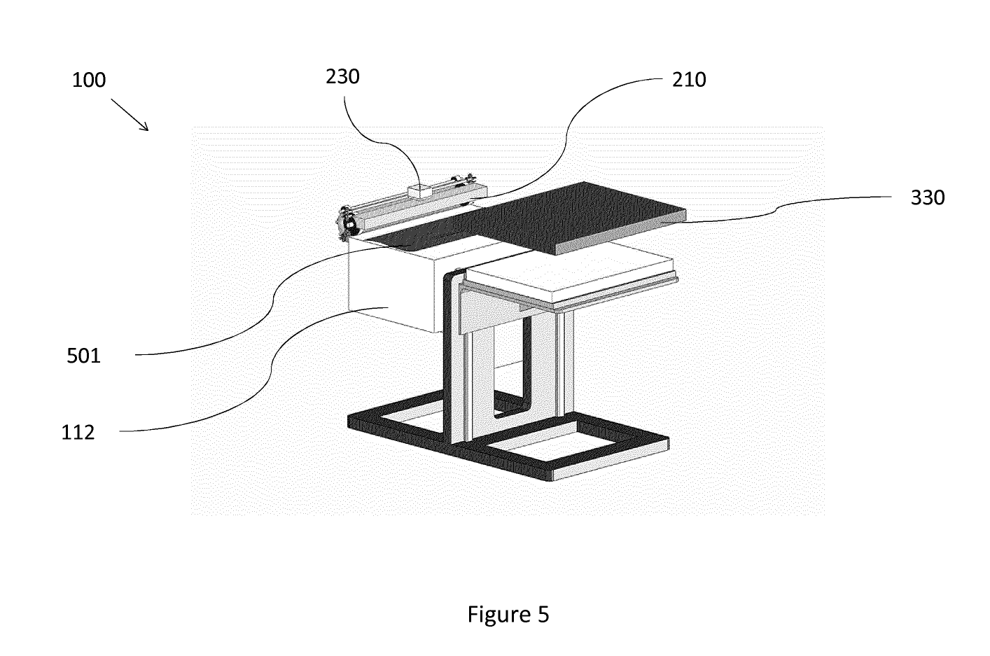

The second stage of the printing process carried out by the printing apparatus 100 is described with reference to FIGS. 4 and 5. The second stage provides for printing on the other side (or second surface 505B) of the sheet that has already passed the first printing stage. As shown in FIG. 4, printing (of an image 600B and/or fiduciary marks 605) on the first surface 505A of the media sheet 501 has been completed.

The printed media layer as it exits the printhead 230 from the first printing pass is returned to the feed tray 111.

In the exemplary arrangement of FIGS. 4 and 5 the sheet is drawn away from the printhead 230 by the grab head 168. The grab head 168 engages the media layer 112 near the leading edge portion thereof. The grab head 168 draws the media layer away from the print head 230 such that the trailing edge portion of the media layer falls onto the top of the stack of unprinted sheets 501 in the tray 111 and returns the media layer to the stack for printing on the second side 50513. In the event that the media layer 501 is the only remaining media layer in the stack 112, it will simply fall directly onto the feed tray 111.

The grab head 168 is configured to move to a position spaced apart from the print head 230, for example, in the direction of or to a position near the build module 300 in order to ensure clearance for the freshly printed media layer 501 exiting from between the print head 230 and sensor 170 to allow the freshly printed media layer 501 to be returned to the stack and placed on the stack 112.

The grab head 168 may be further configured to position the media layer 501 towards the feed roller 161 pick up when depositing the printed media layer 501 on the stack of media layers 112. For example, the grab head 168 may be configured to exert a push force on the media layer 501 in the direction of the feed roller 161.

Once the media layer is correctly positioned over the stack of media sheets 501, the grab head 168 releases the leading edge of media layer 501. It will be understood that the media layer 501 having an image 600B and/or fiduciary marks 605 printed on a first side 505A thereof is returned to the stack 112 of media layers 501 first side facing upwardly for further processing. The returned printed media layer 501 is inverted with respect to its original position on the stack of media layers 112.

Sensors and/or mechanical guides and/or stops and/or mechanical positioning means may be provided to correctly position the media layer 501 back on the stack of media layers 112. Positional sensors may be provided.

FIG. 5 shows an isometric view of the printing apparatus 100 at the same stage of the printing process as shown in FIG. 4. It can be seen that the printed media layer 501 (printed on first side 505A) is being returned to the stack of media layers 112 albeit upside down when compared to its starting orientation. The grab head 168 is not visible in the drawing as it is positioned in proximity to collator or build module 300.

It can be appreciated from the above description with reference to FIGS. 2 to 5 that the present teaching provides a 3D printing apparatus, comprising a paper feed tray 111, a feed roller 161 positioned adjacent the feed tray configured to pick a media layer 501 from the feed tray and pass the media 501 around the roller, and a multifunction head (322/168) configured to grip the media layer 501 after it has passed around the roller to place the sheet back on the paper feed tray 111.

The second stage of the printing process performed by the printing apparatus 100 is similar to the first stage of the process as described with reference to FIGS. 1 and 2. After the printed media layer 501 has been returned to the stack of media layers 112, the printed media layer 501 is again picked by the feed roller 161. The printed media layer 501 is fed through 180 degrees around the feed roller 161 and again inverted such that the unprinted side (in the case of the present specification and apparatus 100, the second surface 505B) of the media layer 501 is presented to the print head 230. The print head 230 can now print the unprinted side 50513 of the media layer 501.

Alignment of the image 600A or other marks printing on the unprinted side with the already printed image 600B or other mark 605 already printed on the first surface 505A of the sheet 501 is crucially important for accurate printing and manufacture of the 3D object. The apparatus 100 of the present specification provides improved alignment of the image 600A on the second side with that on the first 600B. The apparatus 100 is configured to provide alignment as required. In the exemplary arrangement, in the first printing pass image 600B and fiduciary marks 605 are printed on the first side 505A. As the second side 50513 is presented for printing at the printhead 230, sensor 170 senses the fiduciary marks 605 (and/or or a portion of the image 600B). The sensed information is passed to the feed controller 180 and processed to determine any misalignment between the image 600B as printed on the first side of the media layer and the printhead as configured for printing image 600A on the second side of the media layer. If any misalignment is detected, the controller 180 issues a control signal to effect correction in the relative position of the print head 230 and media layer 501.

As noted above an image pair (600A, 600B) is defined for printing back to back on a sheet 501 to define a media layer of the build object. A first image of the image pair to be printed on the medium is printed on a first side of the medium and a second image of the image pair is printed on the second side of the medium back to back to the first image, to define a printed media layer of a 3D object

Therefore, the previously printed image and/or fiduciary marks, which are already printed on the first side of the media layer 501 as the second side of the media layer is presented for printing are used to provide the correct alignment. Sensor 170, which may not be used in the first stage of the printing process, is now used to read the fiducial mark or fiduciary marks 605 on the first printed side (here underside) of the media layer 501 as it passes the sensor 170. The sensor 170 may be arranged to extend across the full width of the media layer 501. Sensor 170 may be configured to sense the image or features of the image printed on the page or to sense any fiduciary marks printed thereon. The sensor senses positional information. The positional information obtained from sensing the image 600B or fiduciary marks 605 is then provided to a controller or processor (not shown). The controller/processor processes the received positional information to exactly determine the position at which the image at the underside of the media layer has been printed. The controller/processor may also determine where the fiduciary marks are printed with respect to the image when the first side of the media layer 501 is printed in the first stage of the printing process.

Having determined the exact position of the image printed on the downward facing first side of the media layer 501, the controller/processor 180 determines if the print head is correctly aligned with the media layer 501. If necessary, the position of the print head may be adjusted to compensate for any misalignment before printing on the second side of the media layer 501 begins.

As previously mentioned, the print head 230 is capable of moving side to side across the width of the media layer. However, the print head is also capable of moving forward and backwards to a limited degree to correctly position itself to align the printing on the top side of the media layer 501 with the already printed bottom side of the media layer.

In an alternative arrangement the controller/processor 180 may make a determination as to whether the printhead is correctly aligned with the media layer 501 and if necessary the position of the media layer may be adjusted.

If no alignment method or device were provided then the print head would assume that the printed media layer 501 has been fed around the roller 161 such that it is positioned exactly as in the first stage of the printing process albeit inverted. In practice, the printed media layer 501 is unlikely to be returned to the top of the roller in exact alignment with its position when first passed through the roller—the first pass shown in FIGS. 1 and 2.

Once the printhead and media layer are determined to be correctly positioned and aligned relative to each other, the print head may begin printing on the second side of the media layer in the normal manner.

The digital print file is again referenced or read by the controller/processor. The digital print file may comprise a series of top-side-bottom-side image pairs for each media layer 701A, 701B . . . etc. Colour image information for both the first side and the second side for all media layers is also contained in the digital print file.

It will be appreciated from the above description with reference to FIGS. 2 to 5 that the present teachings provides a 3D printing apparatus 100, comprising a sensor 170 configured to detect an image 600B or read fiducial mark 605 printed on a first side of a media layer 501; and a printhead 230 configured to print on a second side of the media layer 501, the second side being an opposite side of the sheet to the first side, wherein on reading the fiducial mark 605, the position of the printhead 230 position is adjusted to provide alignment relative to the image or the fiducial mark 605 on the first side of the sheet.

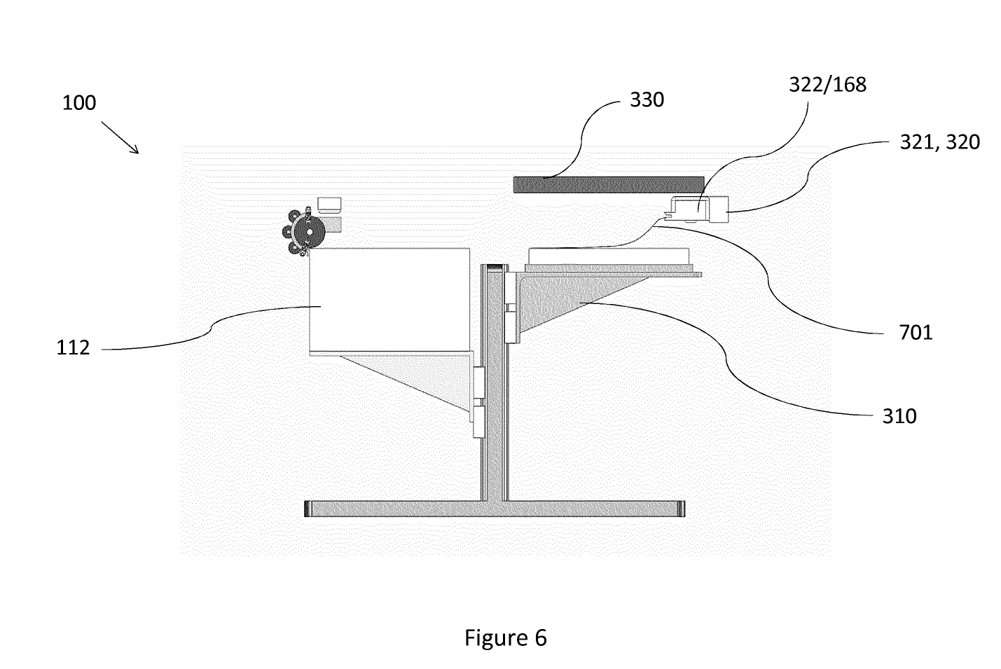

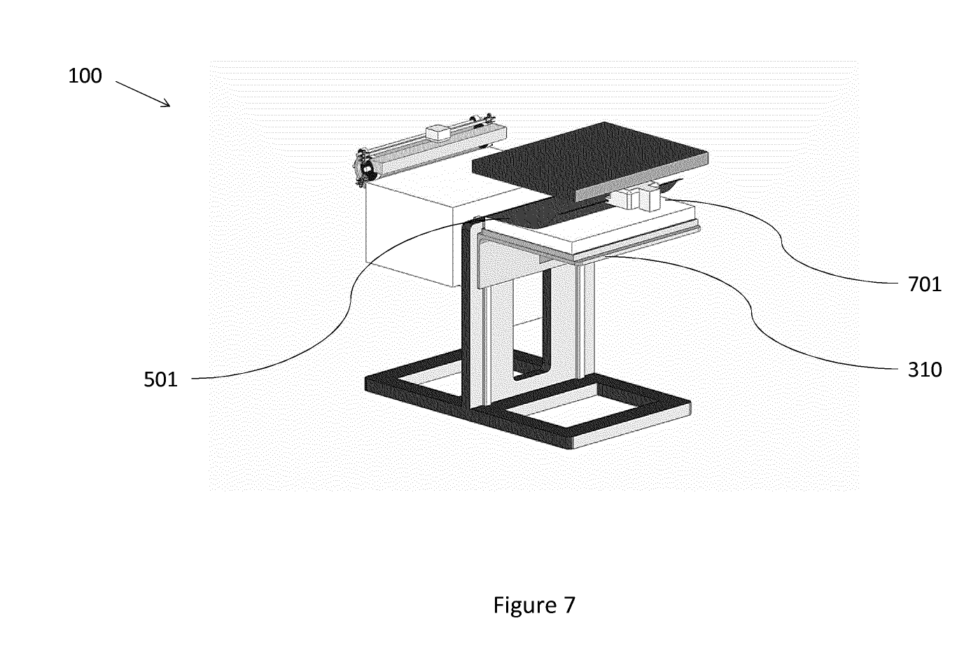

Effectively, in one exemplary arrangement a duplex printing module is provided, comprising: a print head configured to print on a first side of a media layer and print a fiducial on the first side, an optical reader configured to read the fiducial and effect a change in orientation of the print head relative to a second side of the sheet of paper to ensure correct alignment of print media provided on the second side relative to the printed media provided on the first side.
The alignment of the print media provided on the second side may be effected through a software control of the print head.
The apparatus also provides a media layer transport system comprising a feed tray for receiving media layers; a transport mechanism for transporting media layers from the feed tray to a print location; and an optical sensor configured to determine the receipt of a media layer from the feed tray at the transport mechanism and on determination of a non-receipt of a media layer to effect an increase in the bias experienced by the feed tray to move the media layer positively into engagement with the transport mechanism.
The transport mechanism may include a drive roller constituting an inside of a turn portion for changing a direction of the transport path; and one or more pinch rollers that bias the media layers against an outer peripheral surface of the drive roller. The transport mechanism may further comprise one or more turn guides arranged between the pinch rollers to guide the media layers along an outer periphery of the drive roller. The turn guide plates may be formed such that a leading edge of the media layers transported to the turn portion is guided to a contact portion between a pinch roller arranged on a downstream side among the pinch rollers and the drive roller.
The next stage of the 3D printing process carried out by the printing apparatus 100 is shown with reference to FIGS. 6 and 7. It can be seen that the once the media layer 701 has now been printed on both sides, it is not necessary to return the double sided printed media layer 701 to the stack of media 111. Therefore the grab head 168/322 does not drop the media layer on the stack 112 after drawing or pulling it from between the print head 230 and sensor 170. Rather, the media layer is transported to the build plate 310 of build module 300.

As can be seen from FIG. 2, both the feed tray 111 and the build plate 310 are mounted on a frame 101, which is merely exemplary. Any suitable means that is sufficient to support the feed tray 111 and build plate 310 as they move in the direction of the arrows of FIG. 2 may be used.

The media layer 701 is placed (by the grab head) on top of a media layer on the build plate 310 that has already been sliced and had adhesive applied to it. The build plate 310 is configured to move-up (in the direction of the arrows shown) to a heat plate 330 and pressure is applied. This pressure ensures a positive bond between two media layers i.e., media layer 701 and the media layer already resting on the build plate 310.

The build pate 310 is then lowered to allow the multifunction head 322 to return to a position over the build plate 310.

The multifunctional head 322 of the preferred exemplary arrangement includes a blade 321 (not shown). Further an adhesive applicator 320 may be provided mounted on the multifunctional head 322 to apply adhesive to the media layer, as required.

As is known in the art, the blade 321 may be an adjustable Tungsten carbide blade. The multifunctional head manoeuvres to cut the media layer 701 by tracing the object outline to create the edges of the 3D object to be printed. The areas of the media layer that will not form part of the final 3D object are also sliced into small squares. In one arrangement adhesive is then applied. In an exemplary arrangement different adhesives may be applied to different portions of the media layer 701 of the build object depending on whether a portion of the layer 701 is to be weeded or to form a layer of the final object.

The stack forming the build object on the build plate 310 is then ready for another printed media layer to be placed thereon. When another printed media layer 501 is drawn over the top of it, and the stack is pressed up against a heat plate that seals the two layers together.

Once all layers have been cut, glued and pressed together, the object comes out of the printer as a chunky sheaf of paper. But the waste material pre-cut for weeding pulls away denser material of the object itself.

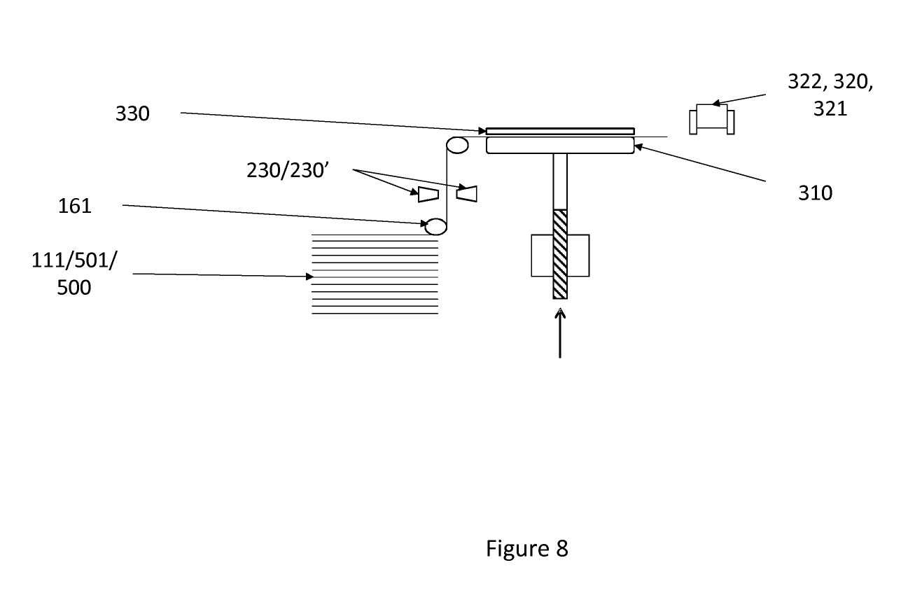

Referring to FIG. 8 in an alternative arrangement, the apparatus 100 may be provided with two print heads 230/230′ to allow simultaneous printing on opposite sides of the medium i.e., simultaneous printing of first and second sides the sheet. Individual sheets 501 are fed and rotated first 90 degrees to pass through oppositely arranged printheads 230/230′. The sheets 501 are then rotated another 90 degrees into the build module 300, where the sheet 501 is grabbed by the multifunctional grab head 322 and transferred to the build location 510. In this arrangement the two surfaces of the sheet are printed simultaneously as the sheet passes between the print heads. In this case the print heads are arranged to print in the generally horizontal direction.

The arrangement of the present specification provides an improved desktop 3D printing apparatus. The apparatus is advantageously configured to provide 2-D printing in single-side or duplex format and 3-D printing of a medium in a continuous in line process. It will be appreciated that in the art 3D printing refers to the LOM process. As described herein, the media to be printed, paper, in the exemplary arrangements of the present specification is provided to the apparatus in sheet or roll format, paper is transported for duplex printing and directly to the build plate for the LOM process.
The arrangement of the present specification may advantageously be used for example for 3D printing of photographs or contour maps. The object manufactured by 3D printing has precision colour to specification throughout the layers of the object. The arrangements of the present specification provide for improved control of colour on first and second surfaces of each layer. The approach provided is high precision and the 3D objects are of improved quality.
The duplex printing module according to the present embodiment may be usefully applied in the context of 3D printing processes. When a media layer is printed from both sides, less image spread occurs, thus providing better image feature dimensional control. No colour interaction between printed layers occurs, which preserves the fidelity of the desired image. However, the duplex printing module according to the present embodiment may be usefully applied in other duplex printing applications where it is important to align images printed on first and second sides of the media layers.
The arrangement of the present specification provides an efficient process.

1. A 3D printing apparatus comprising:
a printing module and a build module provided in a housing,
the printing module comprising a print head for printing of media layers at a print location, and
the build module comprising a build plate for receiving printed media layers from the print module, and adhesive dispensing means, cutting means, and bonding means for forming at the build location a 3D object from the printed media layers;
the apparatus further comprising a continuous media passage defined within the housing between a media input and the build location, and transport means for transporting a media layer from the media input along the media passage to the print location for printing of the media layer, and, to transport the printed media layer from the print location to the build module.

2. The apparatus of claim 1, wherein the build module is configured to manufacture the 3D object by selective deposition lamination (SDL).

3. The apparatus of claim 1, wherein the printing module is configured for single or duplex printing of media layers.

4. The apparatus of claim 1, wherein the printing module and build module are located integrally in a single housing.

5. The apparatus of claim 1, the transport means further comprising
a controller to control transport of media layers through the apparatus, and
a sensor for sensing location and/or alignment of media layers at the print location and at the build location, and
a feed mechanism for feeding the one or more media layers along the media passage.

6. The apparatus of claim 5, wherein the sensor is operable to sense the location of a media layer and/or to sense an image or mark printed on a media layer, and wherein the sensing means provides feedback of sensed information including location, identification or alignment data to the controller.

7. The apparatus of claim 1, the feed mechanism comprising one or more rollers and a pick and place head.

8. The apparatus of claim 1, wherein the rollers and/or pick and place head are further operable to correct errors in location or alignment of media layers.

9. The apparatus of claim 1, the print module configured for duplex printing of the medium, wherein a first image of an image pair to be printed on a media layer is printed on a first side of the medium and a second image of the image pair is printed on the second side of the medium back to back to the first image to define a printed media layer of the object.

10. The apparatus of claim 1 configured to print marks on a first side of a media layer in a first printing pass.

11. The apparatus of claim 1 comprising:
a sensor configured to sense marks printed on a first side of a printed media layer; and
a printhead configured to print on a second side of the media layer, the second side being an opposite side to the first side;
wherein on sensing marks, the printhead position is adjusted to align with the marks.

12. The apparatus of claim 1 wherein the marks comprise fiducial marks.

13. (canceled)

14. The apparatus of claim 1 wherein the marks comprise a portion of an image or the image printed on a first side of the sheet.

15. The apparatus of claim 1, the feed mechanism comprising a feed roller wherein the feed roller is controllable to feed the media layer or adjust the media layer to align the printhead with the marks.

16. The apparatus of claim 1, the feed mechanism comprising a feed tray for receiving a plurality of media layers in sheet form or receptacle for receiving the media layers in continuous roll form.

17. The apparatus of claim 1, the feed mechanism comprising a pick and place roller positioned adjacent the feed tray wherein the roller is configured to pick a sheet from the feed tray and pass the sheet around the feed roller to the printhead.

18. The apparatus of claim 15, wherein the feed roller is configured to invert the sheet from a first orientation as it is passed around the feed roller.

19. The apparatus of claim 1, further comprising a pick and place head configured to grip the sheet after it has passed around the feed roller to place the sheet back on the paper feed tray.

20. The apparatus of claim 15, further configured for returning a media layer printed on a first side to the feed tray for feeding to the printhead for printing on the second side.

21. The apparatus of claim 1, being configured for duplex printing of a media layers and to transport a duplex printed media layer to the build module.

22. The apparatus of claim 1, wherein
the print module and build module are arranged in-line in a single integrated apparatus, and
the transport means is configured to transport each media layers in turn from an input tray to the print module and from the print module to the build module in a continuous in-line transport operation.

23. The apparatus of claim 1, the print module and build module are configured to operate simultaneously, as media layers are transported through the apparatus.

24. The apparatus of claim 1, wherein the print module and build module are independently operable.

25. The apparatus of claim 1, wherein the feed mechanism comprises:
a first feed mechanism for transporting media layers to a print location for effecting a printing of the media layers, and
a second feed mechanism for transporting printed media layers from the print location to the build module.

26. The apparatus of claim 25, wherein the second feed mechanism is configured to transport printed media layers from the print location to the first feed tray.

27. The apparatus of claim 25 wherein the second feed mechanism is configured to reverse a first-side printed layer before transporting it to the first feed tray. 28-29. (canceled)

30. The apparatus of claim 7 wherein the pick and place head 168 is mounted for movement across the printing module 200 and the build module 300 of desktop 3D printing apparatus 100 to locate or transport a media layer.

31. A desktop 3D printing apparatus, comprising:
a printing module for printing media layers and
a collator module for collating printed media layers to build a 3D object; and
a feed mechanism having a first feed tray for receiving a plurality of media layers and configured to transport media layers from the first feed tray to a print location for effecting a printing of the media layers, and to transport the printed media layers from the print location to the build location for effecting a building of the 3D object; and
wherein the printing module and the collator module are provided coupled together in a single integrated apparatus, and the feed mechanism is configured to transport individual media layers from an input through the printing module and to collator module for assembly to form a 3D object in a continuous in-line process.

32. A duplex printing module for a 3D printing apparatus comprising:
a feed mechanism configured to:
transport media layers from a first feed tray for receiving media layers for printing to a print location for effecting a printing of the media layers on a first side of the media layers,
transport the first side printed media layers from the print location to the first feed tray,
transport the first side printed media layers from the first feed tray to the print location for effecting a printing of that media on a second side, and
transport the duplex printed media layers from the print location to a build location or 3D printing.

33. A duplex printing module as claimed in claim 32 comprising:
a print head configured to print on a first side of a media layer and to print a machine readable position locator on the first side of a media layer,
an optical reader configured to read the machine readable position locator and effect a change in position of the print head relative to a second side of the media layer to ensure correct alignment of print media to be provided on the second side relative to the printed media provided on the first side.

34. The module of claim 32, wherein the print head is configured to move in X and Y directions relative to the plane of the media layer.

35. The module of claims 32, wherein the optical reader is configured to read the machine readable position locator while the second side is positioned at a print location relative to the print head ready for printing.

36-38. (canceled)

39. A duplex printing module comprising:
a print head configured to print on a first side of a media layer and to print one or more machine readable position locators on the first side of the media layer,
an optical reader configured to read the machine readable position locators and effect a change in orientation of at least one of:
the print head relative to a second side of the media layer to ensure correct alignment of printing on the second side relative to the printing media provided on the first side, or
the media layer relative to a profiling module for cutting the media layer.

40. The module of claim 39, wherein the optical reader is configured to read the machine readable position locators and effect a change in orientation of the print head relative to a second side of the media layer.

41. The module of claim 39 wherein the optical reader is configured to read the machine readable position locators and effect a change in orientation of the media layer relative to a profiling module for cutting the media layer.

42. A media layer feed mechanism for a 3D printing apparatus comprising a first feed tray, first feed mechanism and second feed mechanism configured to:
transport media layers from a first feed tray for receiving media layers for printing to a print location for effecting a printing of the media layers on a first side of the media layers,
transport the first side printed media layers from the print location to the first feed tray,
transport the first side printed media layers from the first feed tray to the print location for effecting a printing of that media on a second side, and
transport the duplex printed media layers from the print location to the build location.

43. The apparatus of claim 42, wherein the feed mechanism comprises:
a first feed mechanism configured to transport media layers a print location for effecting a printing of the media layers, and a second feed mechanism configured to transport printed media layers from the print location to the collator module.

44. The apparatus of claim 42, wherein the second feed mechanism is configured to transport printed media layers from the print location to the first feed tray.

45. The apparatus of claim 42 wherein the second feed mechanism is configured to reverse a first-side printed layer before transporting it to the first feed tray.

46. The apparatus of claims 42, wherein the first feed mechanism comprises a feed roller.

47. The apparatus of claims 42 wherein the second feed mechanism comprises a pick and place head.

48. (canceled)

49. The desktop 3D printing apparatus of claim 1, further comprising a collator module configured to assemble a plurality of individual printed media layers to form a three-dimensional (3D) object.

50. (canceled)

51. The desktop 3D printing apparatus of claim 49, wherein the collator comprises a bonding module configured to bond individual ones of the plurality of media layers of individual media layers and a profiling module to cut the individual media layers.

52. A desktop 3D printing apparatus as claimed in claim 1 wherein the feed mechanism defines a medium transport path, therein the medium is transported to a first print station for printing on a first surface of the medium and from the first print station to a second print station for printing on a second surface of the medium.

53. The apparatus of claim 53 wherein the first and second print stations are co-located.

54. The apparatus of claim 53 wherein the first and second print stations are located spaced apart.

55. The apparatus of claim 54 comprising a printhead, wherein the printhead is moveable between the first and second printing stations to effect printing on the first surface of the medium and on the second surface of the medium.

56. The apparatus of claim 54 comprising first and second printhead for printing simultaneously on first and second surface of the medium at first and second print stations.

57. The apparatus of claim 53 wherein the first and second print heads are arrangement to print the first and second surfaces of the sheet as the sheet is between the print heads.
